(19) United States
(12) Patent Application Publication
(10) Pub. No.: US 2012/0209699 A1
(43) Pub. Date: Aug. 16, 2012

(54) Complementary Professional Co-Marketing System

(76) Inventors: Gregory D. Cochran, Portland, OR (US); Brandon Barnum, Portland, OR (US)

(21) Appl. No.: 13/026,126

(22) Filed: Feb. 11, 2011

(51) Int. Cl. G06Q 30/00

(52) U.S. Cl. 705/14.49; 705/1.1

(57) ABSTRACT

An issue and web-based turnkey marketing system that serves as a professional marketing co-op is disclosed. The system allows a professional in a given specialty to license one or more geographical regions by zip code, defining that region as his, partially protected marketing region for his specialty. The system provides each professional with a unique website in which to refer clients. When potential clients log onto a professional's unique website, the site is populated not only with the providing professional's profile, but also with the profiles of complementary professionals. Under the system, professionals cross-market other professionals' services, generating leads and expanding each professional's referral network within a zip code. Referrals as well as potential clients are tracked via the system.

### BACKGROUND OF THE INVENTION

The marketing of professional services is all about building relationships. In the past many working professionals simply believed that outstanding work speaks for itself. That is, if you do great work, your client will hire you when new needs arise. However, in today's business environment, with company web pages, web-based networking tools, such as LinkedIn, and viral marketing campaigns, one cannot assume that great performance alone will travel through a client's organization, and beyond, without sustained effort. Additionally, traditional marketing campaigns, such as direct mail, are typically not a favored marketing avenue for professionals. Attorneys and accountants are not selling new windows or magazine subscriptions, but instead providing advice regarding issues that are often sensitive in nature.

How do tax professionals, mortgage professionals, attorneys, and real-estate professionals, to name just a few, initiate and sustain relationships with clients? What is needed is an issue-oriented, web-based platform that allows professionals to detail their understanding of a specific problem (issue), as well as address how they have specifically helped other clients in a similar situation (i.e., previous clients that faced the same problem).

### SUMMARY OF THE INVENTION

The present invention is a system and method for complementary professional networking, allowing business professionals to co-market one another's professional services. Professionals unite around a single issue to market their services via a web-based, turn-key marketing system. Complementary professionals, those that offer non-competing services, can cross-market one another's services, around the client's specific problem/issue, often within a given territory, while simultaneously tracking those referrals, building a referral team.

Features of the system include a geographically based, priority referral system, in which professionals license zip codes. Unique web address, co-branded with the professional's profile and the ubiquitous issue, unifying complementary professionals within a protected market are provided via the system. The professional co-marketing system links individuals not business entities.

An extensive catalogue of ready-to-print marketing materials to further expand relationships, is also included in the system. Should a professional decide to “follow-up” with a potential client or complementary professional he met via an email or letter, he simply needs to choose his desired means of communication (email or letter), choose the appropriate language from the system catalogue, and the professional co-marketing system will automatically customize the language with his contact information. Additionally, social media tools are provided via the system to aid each professional with creating “Facebook fans” and/or “Twitter follwers.”

Referrals are tracked via the system keeping each professional apprised of how much web-traffic and referral activity he receives via the system. These analytics are real-time reports on the marketing and referral activity that is occurring via the system. This empowers each professional with the knowledge as to which complementary professionals are actively promoting his services to their existing client base. This feature allows professional of one specialty to foster relationships with professionals of other specialties (complementary professionals) that are most actively marketing one another.

### BRIEF DESCRIPTION OF THE DRAWINGS

FIG. 1 is a block diagram illustrating one embodiment of the complementary co-marketing system of the invention connected to a network;

FIG. 2 is a visual aid illustrating the various categories under an embodiment of the invention;

FIG. 3 is a visual aid illustrating potential data channels through which the co-marketing engine refers complementary professionals to potential clients;

FIG. 4 is a first block diagram illustrating the professional priority logic under an embodiment of the invention;

FIG. 5 is a second block diagram illustrating the professional priority logic under an embodiment of the invention;

FIG. 6 is a third block diagram illustrating the professional priority logic under an embodiment of the invention;

FIG. 7 is a block diagram illustrating the formation of a unique professional webpage under an embodiment of the invention; and

### DETAILED DESCRIPTION OF THE DRAWINGS

The system and method for complementary professional co-marketing is described below with specific reference to the issue of divorce. It will be appreciated that the system and method for complementary professional co-marketing may be applied to numerous complex issues, from starting a new business to end-of-life planning, without departing from the scope of the present invention.

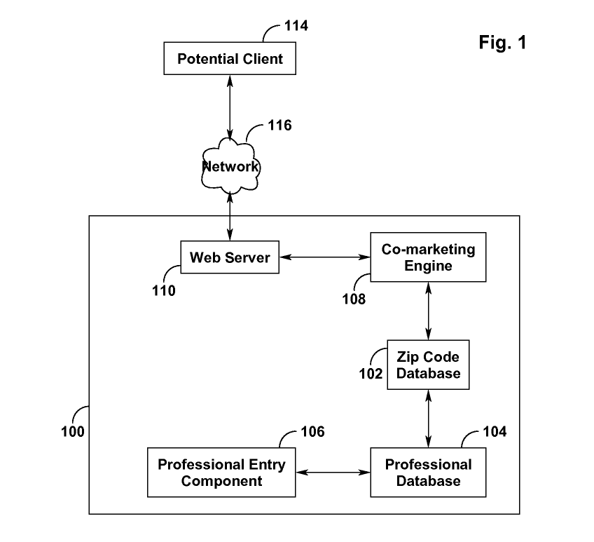

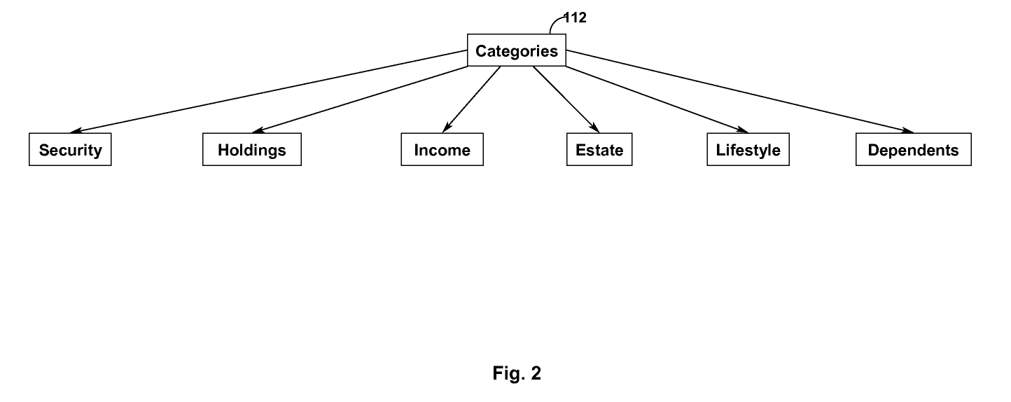

FIG. 1 is a block diagram that illustrates one implementation of the complementary professional co-marketing system connected to a network. The complementary professional co-marketing system 100, described herein, may be implemented in the context of divorce. Divorce is an all-encompassing life event that can require an individual to seek consultation from numerous professionals. Often individuals going through a divorce will consult or use the services of divorce attorneys, accountants, financial planners, tax professionals, marriage counselors, mediators, mortgage professionals, real estate agents, estate planning attorneys, bankruptcy attorneys, and insurance agents. As shown in FIG. 2 the categories 112 from which individuals seek professional advice are illustrated. Categories 112, are the broad areas from with an individual seeking a divorce would seek information. For example, FIG. 2 shows six categories: security, holdings, income, estate, lifestyle, and dependants. An individual considering divorce may have concerns about her “Holdings” and as such would seek advice from a financial planner, or she may have questions about her “Estate” and would advice from an estate planning attorney. Categories 112 are broad and arbitrary, meant only as a convenient way to group professionals together for a certain issue, and potentially limit the types of professionals that are allowed to participate in system 100. For example if the issue being addressed via system 100 is divorce, system 100 may restrict the licensing of zip codes to certain occupations, only allowing divorce attorneys, accountants, financial planners, tax professionals, marriage counselors, mediators, mortgage professionals, real estate agents, estate planning attorneys, bankruptcy attorneys, and insurance agents, to participate.

An example of such a complementary professional co-marketing system can be found at the website www.divorceshield.com. Clients can be driven or directed to the website via search engine optimization based on related key word searches such as “divorce,” as is well known in the field. This website prompts an individual (potential client) who is interested in obtaining a divorce, or interested in obtaining advice concerning divorce, to enter her contact information, or a set of characteristics, into a web-based form which generates a free divorce plan for the potential client and generates a listing of various professionals from the categories 112 within a geographically proximate area (pre-defined by her zip code and surrounding zip codes) to the requesting individual. Generally, a web server interacts with both the potential client seeking a divorce and the professionals potentially providing advice to the client. However, the invention is not limited to the use of a web server and can be implemented using any server on a network (not connected to the Internet).

Components of the complementary professional co-marketing system 100 include a zip code database 102, a professional database 104, professional entry component 106, a co-marketing engine 108, and a web server 110. When a potential client 114 accesses the web server 110 over a network 116 such as the Internet, the web server 110 serves web pages that prompt the potential client 114 to enter her name, email, and zip code.

The zip code database 102 contains and stores a listing of all zip codes with a pre-defined geographical area. Within the context of complementary professional co-marketing, professionals are recommended to consumers based on zip codes; zip codes licensed by a professional(s).

Professional database 104 contains and stores a listing of all professionals who have licensed zip codes. In the context of complementary professional co-marketing “licensing” occurs when a professional pays to have her profile featured to the potential client via the web server 110.

The term “database” as used with respect to the zip code database 102, encompasses any group of data that stores information about zip codes within a defined geographical area. The zip code database 102 is not limited to any particular format, and may be a text file. The zip code database 102 need not require a relational database management system for accessing the information stored therein. Alternatively, the zip code database 102 may comprise all or portions of many computer files stored in one or more directories or folders.

The term “database” as used with respect to the professional database 104, encompasses any group of data that stores information about professionals within a defined geographical area. The professional database 104 is not limited to any particular format, and may be a text file. The professional database 104 need not require a relational database management system for accessing the information stored therein. Alternatively, the professional database 104 may comprise all or portions of many computer files stored in one or more directories or folders.

Generally the professional entry component 106 comprises computer-executable instructions stored on a computer readable medium that are configured, when executed by a general purpose computer to allow a user (professional) to create and/or update the professional database 104. Professional entry component 106 is accessible to a plurality of professionals over a network such that professionals can directly create or update/edit their own professional profile.

Potential client 114 characteristics are collected via a web-based form served by the web server 110. Potential client 114 is asked, at a minimum, to provide her name, email address, and zip code via a general purpose computer or smart phone. It should be noted that a “general purpose computer” or “smart phone” are well know in the industry and comprise a processor configured to cause its hardware components to perform a set of instructions.

Generally, co-marketing engine 108 comprises computer executable instructions stored on a computer readable medium that are configured, when executed by a general purpose computer or smart phone to match the potential client 114 with a grouping of complementary professionals within her zip code or within a proximate zip code. Since the professionals are complementary, each potential client 114 is an exclusive lead for each professional that has licensed that zip code.

It should be noted that under an alternate embodiment, the number of professionals that can license a single zip code could vary. For example, the system could allow up to three professionals within the same discipline to license a zip code. Allowing more than one professional within a given discipline to license a zip code provides the potential client with more flexibility to find the right professional fit, while still maintaining a protected geographic are for the licensing professionals.

Professionals via the professional entry component 106 can create their unique professional profile and designate a unique Uniform Resource Locator “URL.” Professionals provide their unique URL to their existing clients or potential clients they may encounter through friends or family, for example. When that potential client goes to that URL she will see not only the professional profile of the professional that gave her his unique URL, but will also see all the complementary professionals that have licensed that zip code (one professional per categories 112), under one embodiment of the invention. Each professional who uses system 100 to promote their business is simultaneously promoting each of the other complementary professionals who licensed that zip code.

Under an alternate embodiment of the complementary professional co-marketing system 100, when a potential client 114 downloads a plan via a professional's unique URL, the potential client 114 sees (i.e. the webpage is populated with) complementary professionals that are specifically recommended by the referring professional. If there is a category 112 from which the referring professional has no recommendation to the potential client 114, the co-marketing engine will populate that category with a professional who has licensed that zip code.

FIG. 2 illustrates the broad categories 112 that a potential client 114 faces during the divorce process: security; holdings; income; estate; lifestyle; dependents. These categories have been chosen as a means for addressing the most common issues of concern to individuals considering divorce, and for referring business professional that operate within those broad categories. A skilled artisan will appreciate that the aforementioned categories could differ based on issue being addressed (e.g. end-of-life planning, starting a new business, etc.) without departing from the scope of the invention.

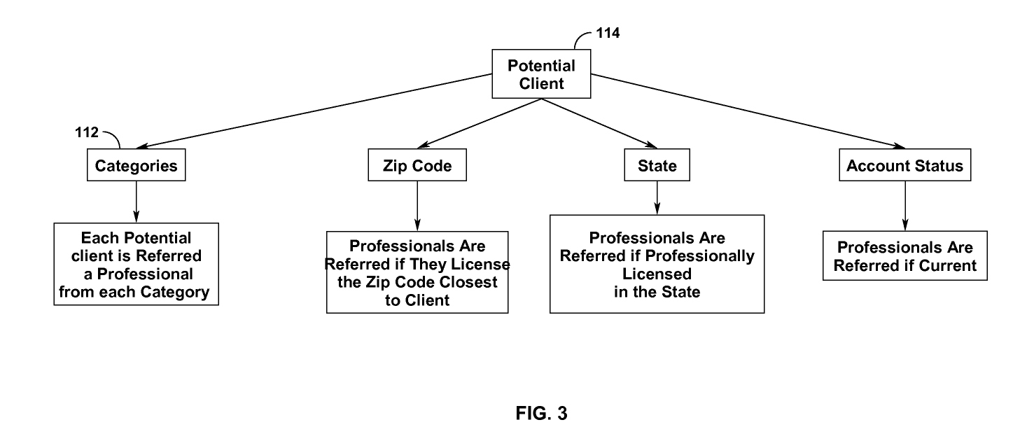

Turning now to FIG. 3 the block diagram generally illustrates the data channels through which the co-marketing engine 108 refers complementary professionals to potential clients 114. Potential clients 114 are referred to professionals from each of the six defined categories 112 shown in FIG. 2. Professionals will be referred in the potential client's 114 zip code. If no professional has licensed the zip code that the potential client 114 entered over the web server 110, a professional from a neighboring zip code will be referred. If still no professional has licensed a neighboring zip code, a professional within the same state will be referred. Professionals are only referred if their account status is active within the system 100 and they are professionally licensed within the State of the requesting potential client.

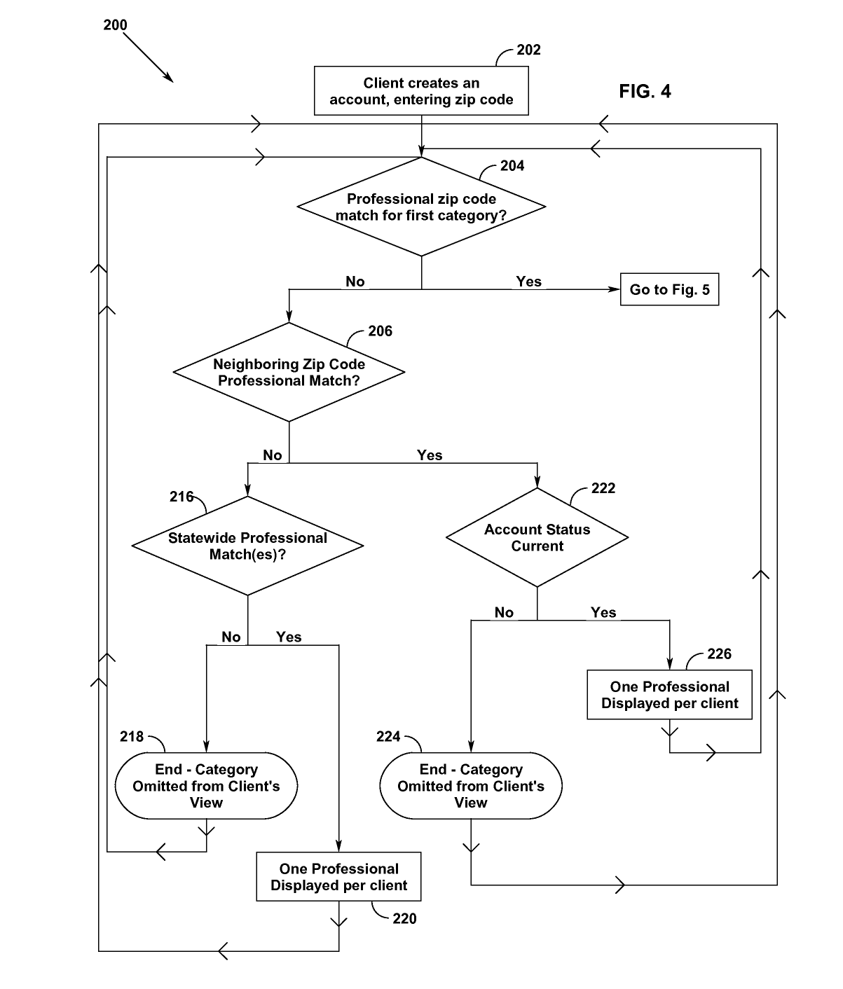

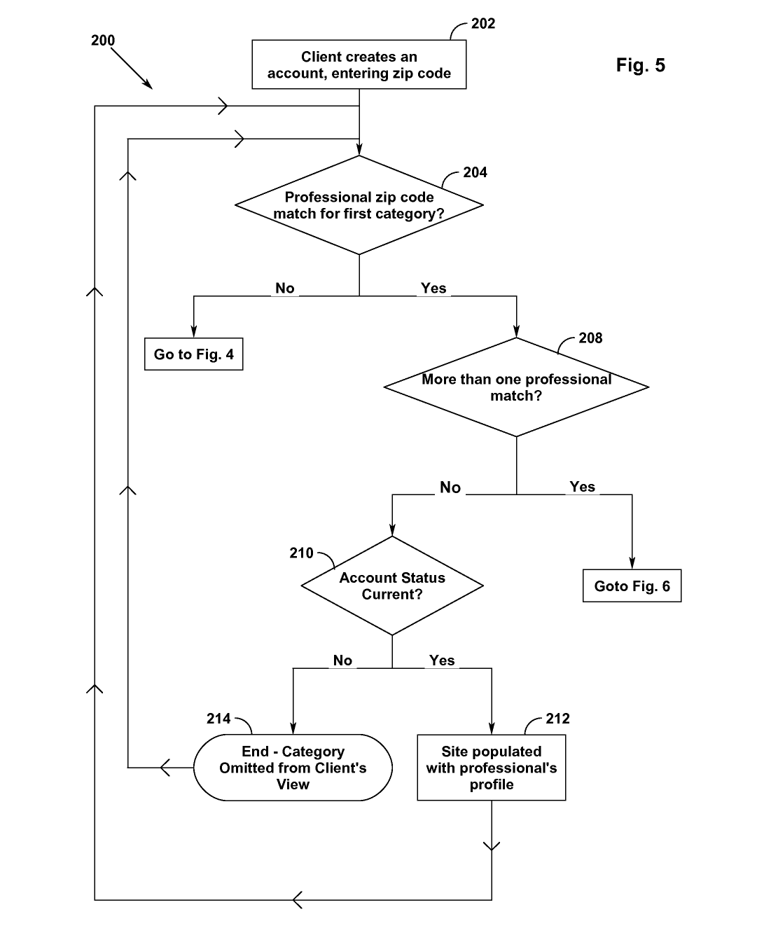

Looking at FIGS. 4, 5, and 6 one process of complementary professional co-marketing 200 that may be preformed by the system 100 of FIG. 1 is illustrated. Referring to FIG. 4, the process 200 begins, in block 202, by the potential client 114 creating an account. In creating an account the potential client enters her name, email address, and zip code. If there is no professional zip code match for the first category 112, decision 204, the process 200 proceeds to inquiring if there is neighboring zip code professional match, decision 206. If there is a professional zip code match for the first category 112, decision 204, the process 200 proceeds to inquiring if there is more than one profession matches, decision 208; see FIG. 5. Still referring to FIG. 4, if there is no neighboring zip code professional match, decision 206, process 200 proceeds to inquire if there is a statewide professional match(es), decision 216. If there are no Statewide professional matches, the first category is omitted from the potential client's view (i.e., no professional is referenced), step 218, and the process 200 returns to decision 204, inquiring if there is a professional zip code match for the second category, third category, etc, until all defined categories are exhausted. If there is/are Statewide professionals matches, decision 216, one professional is displayed per potential client, block 220. Process 200, will rotate through the statewide professionals as each new potential client 114 creates an account. After one statewide professional is displayed, block 220, the process 200 returns to decision 204, inquiring if there is a professional zip code match for the second category, third category, etc, until all defined categories are exhausted.

Returning to decision 206, if there is/are neighboring zip code match(es), process 200 inquires if the account status is current, decision 222. If the account status is not current, the category is omitted from the potential client's view, step 224, and process 200 returns to decision 204, inquiring if there is a professional zip code match for the second category, third category, etc, until all defined categories are exhausted. If there is/are neighboring professionals matches, decision 206, one professional is displayed per potential client, block 226. Process 200, will rotate through the neighboring professionals as each new potential client 114 creates an account. After one neighboring professional is displayed, block 226, the process 200 returns to decision 204, inquiring if there is a professional zip code match for the second category, third category, etc, until all defined categories are exhausted.

Turning now to FIG. 5, if there is a professional zip code match for the first category 112, decision 204, the process 200 proceeds to inquiring if there is more than one professional match, decision 208. If there is not more than one professional match, the process 200, inquires as to whether the account status is current, decision 210. If the account status is current the website is populated with that professional's profile, block 212. If the account status in not current, that category is omitted from the client's view, step 214, and the system returns to decision step 204, to find a professional match for the second category third category, etc, until all defined categories are exhausted.

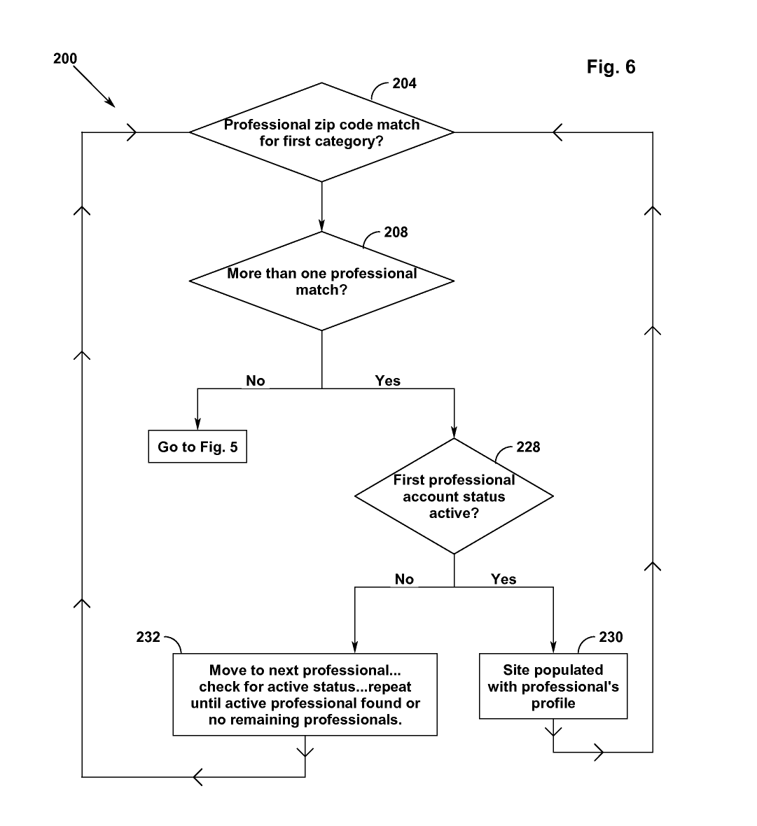

Referring to FIG. 6 illustrates process 200 if the system 100 determines that there is more than one professional match, decision 208. Process 200 inquires if the first professional's account status is active, decision 228. If the first professional's account status is active, the web site is populated with the professional profile of that professional, block 230. Process 200 then returns to decision 204, inquiring if there is a professional zip code match for the second category, third category, etc, until all defined categories are exhausted. If the first professional's account status is inactive, decision 228, process 200, moves to the next professional to check for active status, repeating this process until an active professional is found (website would then be populated with that active professional's profile) or until no remaining professionals are found, block 232. Again, process 200 will return to decision 204, inquiring if there is a professional zip code match for the second category, third category, etc, until all defined categories are exhausted. It should be noted that a professional's account status will always be confirmed by process 200, before his information is displayed to a potential client 114. For ease of reading, this step is not shown if every instance it is relied upon in FIGS. 4 and 5.

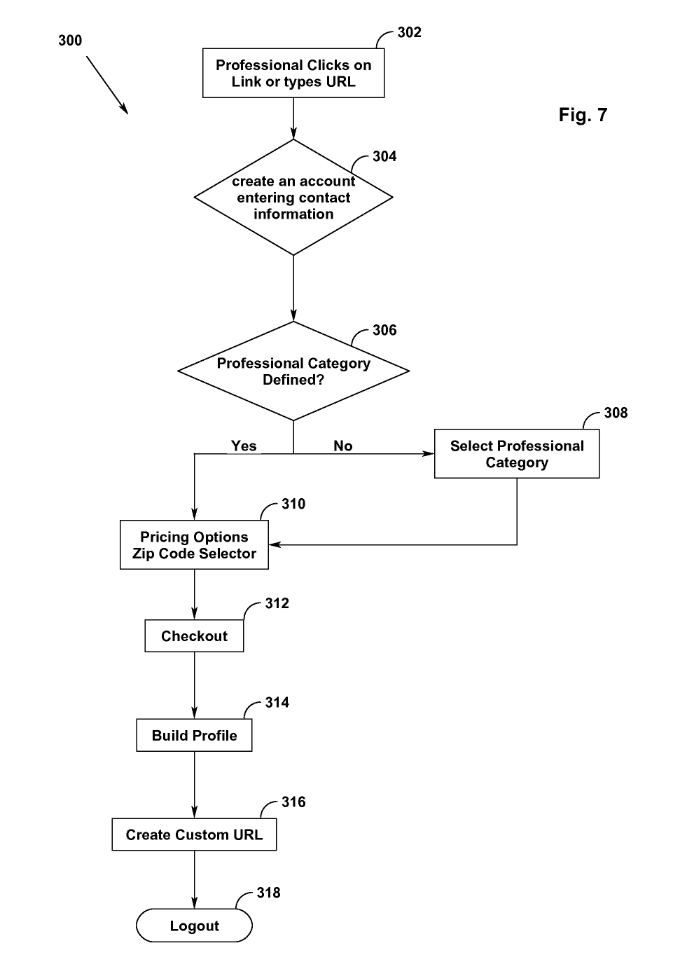

Turning now to FIG. 7, the general process by which a professional creates and modifies/edits his existing profile via professional entry component 106, is illustrated. Process 300, begins when a professional clicks on link or types the URL, block 302. Process 300 continues with the professional entering his contact information via web-based form, block 304. Next, process 300 inquires if his professional category is defined, decision 306. “Professional Category” is simply a concise job description, for example, tax attorney, financial advisor, mortgage broker, real estate agent, etc. If the professional category is not defined, the professional is prompted to select a professional category, block 308, from a drop-down menu. After the professional has selected his professional category (or if his professional category is already defined), the professional next selects the zip codes he would like to license, block 310. While professionals are always welcome to license any zip code that is available under system 100, system 100 will suggest zip codes to each professional based on 1.) proximity to that professional's office; 2.) population of a zip code; 3.) number of households within a zip code; 4.) average income of a zip code; and 5.) availability in the licensing professional's category. Different pricing options are available to the professional based on how many zip codes he licenses. After selecting the desired zip codes, process 300 requires that he “checkout” by purchasing those zip codes, block 312. Once the professional has checked out, the professional is able to now to build his professional profile, block 314, and finally create his custom URL, block 316, and can finally logout, step 318.

Complete customization of the professional profile, block 314, is available via system 100. For example, besides the standard contact information, professionals can choose to display a link to social media, and professional media outlets, such as Facebook and LinkedIn, display their educational background, personal interests, awards and accomplishments, and reasons for serving divorce clients.

We have described the aforementioned by way of example not limitation. One skilled in the art will appreciate that variations of the disclosed embodiments and modifications or omissions of features of the embodiments disclosed herein will not depart from the scope of the invention.

What is claimed is:

1. An issue based, complementary professional co-marketing system comprising:
a zip code database configured to store zip codes within a pre-defined area;
a professional database configured to store a listing of professionals, who have licensed zip codes contained within said zip code database; and
computer hardware in communication with said zip code database and said professional database comprising at least one computer processor configured to cause the computer hardware to perform operations comprising:
requesting a potential client's zip code;
matching said potential client with at least two professionals who have licensed said zip code; and
transmitting the contact information of said professionals to said potential client.

2. The issued based, complementary professional co-marketing system of claim 1 further comprising defined professional categories based on said issue.

3. The issue based, complementary professional co-marketing system of claim 2 further comprising a professional entry component, wherein said professional entry component comprises computer executable instructions stored on a computer readable medium.

4. The issue based, complementary professional co-marketing system of claim 3 wherein, when said computer executable instruction of said professional entry component are executed by a general purpose computer allowing a professional to create a professional profile and edit said professional profile.

5. The issue based, complementary professional co-marketing system of claim 4 wherein said issue is divorce.

6. The issue based, complementary professional co-marketing system of claim 5 wherein said categories are defined as: security; holdings; income; estate; lifestyle; and dependants.

7. The issue based, complementary professional co-marketing system of claim 6 further comprising a catalogue of print-ready marketing material accessible to said professionals listed in said professional database.

8. An issue based, complementary professional co-marketing method comprising:
accessing a plurality of computer-executable instructions from at least one computer-readable medium; and
executing the computer-executable instructions on at least one computer processor, thereby causing computer hardware to perform operations comprising:
receiving computer-readable data encoded with a set of professional characteristics, having information about a professional that is sufficient to create an account;
receiving computer-readable data indicative of a professional's professional category;
causing a computer to generate a list of zip codes based on said professional's characteristics;
allowing said professional to license one or more zip codes from said list of zip codes;
receiving computer-readable data encoded with a set of potential client characteristics including a zip code; and
matching said potential client with one or more said professionals.

9. The issue based, complementary professional co-marketing method of claim 8 further comprising causing a computer to present an unique URL, featuring said professional's characteristics.

10. The issue based, complementary professional co-marketing method of claim 9 further comprising allowing said professional to modify/edit the content of said unique URL.

11. The issue based, complementary professional co-marketing method of claim 10 wherein said professional categories are pre-defined based on said issue.

12. The issue based, complementary professional co-marketing method of claim 11 wherein matching said potential client with one or more said professionals comprises transmitting said unique URLs to said potential client.

13. A computer-readable medium storing computer-executable instructions that are configured, when executed by a computer to perform the operations of:
receiving a set of professional characteristics having enough information about a professional to generate an account;
asking for the professional to select or define his professional category;
generating a list of zip codes based on said set of professional characteristics;
allowing said professional to license one or more zip codes;
allowing said professional to build a professional profile;
creating a custom URL for said professional profile;

14. The computer readable medium of storing computer-executable instructions of claim 13 wherein the computer-executable instructions are further configured, when executed by a computer to perform the operations of:
receiving a set of characteristics from a potential client including a zip code;
matching said potential client with one or more professionals based on the set of characteristics received from the potential client, such that said potential client can view the professional profiles of each matched professional.

15. The computer readable medium of storing computer-executable instructions of claim 14 wherein the computer-executable instructions are further configured, when executed by a computer to perform the operation of:
limiting the number of professional categories; and
limiting the number of professionals from a single professional category that can license a zip code.

16. The computer readable medium of storing computer-executable instructions of claim 15 wherein the computer-executable instructions are further configured, when executed by a computer to perform the operation of:
allowing said professional to recommend complimentary professionals via his professional profile and his unique URL.
